(19) United States
(12) Patent Application Publication
(10) Pub. No.: US 2024/0092536 A1
(43) Pub. Date: Mar. 21, 2024

(54) BAG, METHOD AND DEVICE FOR PRODUCING A BAG

(71) Applicant: Windmöller & Hölscher KG, Lengerich (DE)

(72) Inventors: Jörg Christian THIES, Lengerich (DE); Frank SANDER, Lengerich (DE)

(73) Assignee: Windmöller & Hölscher KG, Lengerich (DE)

(21) Appl. No.: 18/254,273

(22) PCT Filed: Nov. 25, 2021
(86) PCT No.: PCT/EP2021/083025

§ 371 Date: May 24, 2023

(30) Foreign Application Priority Data
Nov. 27, 2020 (DE) 10 2020 214 975.5

(51) Int. Cl. B65D 33/08; B31B 70/86; B65D 30/20; B65D 33/02

(52) U.S. Cl. CPC B65D 33/08; B31B 70/872; B31B 70/874; B65D 31/10; B65D 33/02; B31B 2150/003

(57) ABSTRACT

The invention describes a bag (300) having a first wall and a second wall that comprise paper and that are connected to one another by lateral edges such that a fill space is provided, wherein the second wall projects above the first wall as seen in the longitudinal direction of the bag, and having two ends, wherein a bottom is arranged on one end and an opening is provided on the other end, through which the fill space is accessible, wherein the bottom comprises at least one folding region of the second wall, wherein the folding region is folded over at least parts of the first wall about a crease line, and having at least one handle opening (109, 109′).

The invention is characterized by the handle opening (109, 109′) through which the second wall reaches outside of the folding region and through the folding region.

The invention relates to a bag pursuant to the preamble in claim 1, and to a method and a device for producing a bag.

Bags, in particular paper bags, have been known for decades and are used on a daily basis in very large quantities. A known bag
having a first wall and a second wall that are connected to each other by lateral edges—thus creating a fill space—and
having two ends, wherein a bottom is arranged on one end and an opening is provided on the other end, through which the fill space is accessible, wherein the bottom comprises at least one folding region of the second wall, wherein the folding region is folded over at least parts of the first wall about a crease line,
represents the point of origin for the present invention.

The bags described above are suited for a wide range of applications. For example, end users can bag and transport merchandise purchased from retailers into such bags. Baked goods can for example be transported by sealing the opening with single or multiple fold-overs and/or crumpling after the goods are bagged. The folded over end—which previously represented the opening—can also be securely sealed, for example by using an adhesive, such as an adhesive strip.

DE 10 2012 104 619 A1 describes such a bag, which comprises handle openings in the region of the opening, such that a user can more readily carry a bag filled with merchandise.

But such bags with handle openings are not suited for applications deviating therefrom. The bags can for example not be filled with goods and be readily sealed such that the fill space is sealed against the environment. These bags are therefore for example not suited for mail order applications.

The task of the present invention is therefore to propose a bag according to the class with handle openings that is suited for further applications.

The task is solved by a bag according to claim 1. Enhancements and advantageous embodiments of an inventive bag are described in claims 2 to 7 and in the description below.

An inventive bag that comprises the features of claim 1 (as stated in the preamble) is characterized in that the
handle opening reaches through the second wall outside of the folding region and through the folding region. The handle openings are therefore already incorporated in the finished bottom, such that the bag can be particularly conveniently filled through the remaining opening without the handle opening interfering with the filling operation. When the inventive bags are for example used in retail applications, it is essential that the latter can be filled quickly. Any interference is to be avoided. Hereinafter, the term “Bottom Flap” is also used in lieu of the term “Folding Region.”

An inventive handle opening can be provided for the bag at various points in the manufacturing process. The steps required for this can be performed when a material strip is available as the raw material, but before the material strip is formed into a tube from which the subsequent bags are separated. This then involves preparing the handle openings at two different locations for an individual bag, specifically on the subsequent folding region and on the subsequent second wall outside of the folding region.

The handle openings can of course be incorporated on the subsequent folding region and on the second wall outside of the folding region after a tube is separated into tube pieces to form the actual bag. The separation is in particular performed in that two pieces are torn off at the front end of the tube along a previously incorporated weakening line, in particular a perforation. After the separation step, a tube piece is available having a first wall and having a second wall that are connected to each other by lateral edges, wherein the second wall projects above the first wall as seen in length direction of the bag. However, a bottom has not yet been formed. In this state, two openings can in turn be incorporated that subsequently come to lie above one another after the bottom is formed and together represent a handle opening.

However, it is also advantageous to incorporate a handle opening into the bottom only after the bottom is fully formed.

Handle openings can be formed by providing at least one punch by which the material pieces can be detached and removed from the second wall outside of the folding region and/or from the folding region. A knife punch of such a punch can then have a circumferential contour. Alternatively, the contour can also be open such that the material pieces remain on the bottom such that the full handle opening is only created when a user grabs the bag by reaching through the handle opening. A not yet fully formed handle opening prepared in this manner can be created using a perforating knife. A perforation generated using such a perforating knife has the advantage that the material pieces continue to be connected to the bag by a plurality of webs, therefore avoiding interference by folded-over material pieces.

Perforations or punch-outs can also in particular be created contactlessly using a laser cutting apparatus.

A device for creating handle openings can in accordance with the method described above be arranged as seen in production direction between an unrolling device for unrolling a material strip and a tube forming device. Alternatively or additionally, such a device can be arranged between the tube forming device and the bottom folding device. Likewise, it is possible to provide the device for creating handle openings downstream of the bottom folding device, as seen in the production direction.

The terms “first wall” and “second wall” do not imply a directional mapping. This means that the first wall can for example be arranged above or below during the production process. An inventive bag comprises paper or consists completely of paper.

An inventive embodiment of the bag provides that the folding region is connected to the first wall by a first connection surface, wherein the folding region is connected to a second connection surface with a part of the side of the second wall facing the fill space. In particular, this part of the side of the second wall facing the fill space is free from the first wall, e.g., is not covered by the latter. The folding region can then be connected to the first wall and also to the second wall. In particular the connection to the second wall serves the purpose of preventing content located in the fill space from reaching the surrounding area through the handle openings.

A connection surface is defined as the surface by which the aforementioned components, in particular the first wall, the second wall, and the folding region are respectively connected to each other. The connection can be created by applying adhesive and subsequently bringing respectively two components into contact with one another. An adhesive can in particular be cold glue, in particular glue based on starch, a hot melt, e.g., an adhesive activated by exposure to heat, but also two-sided adhesive labels. A glue application apparatus, which for example carries a format piece on a rotating element that corresponds to the connection surface and is in particular elastic, is provided for applying the adhesive. Such a format piece is frequently also called a template. A glue application apparatus can alternatively comprise a nozzle glue application device. Said nozzle glue application device comprises several nozzles whose volumetric glue flow can be generated or interrupted using valves. A nozzle row in transverse direction of the transport direction of the bag is conceivable, wherein the valves are opened or closed as the desired surface of a bag passes by.

It is furthermore advantageous when the second connection surface completely envelops the handle opening. It is in this case preferable when the connection surface directly adjoins the perimeter of the handle opening. A fully enveloped handle opening prevents that on the subsequent bag, the two layers of the handle opening, as formed by the second wall outside of the folding region and by the second wall, separate from each other, causing the user to have greater difficulty grabbing the bag.

An advantageous embodiment provides that the first and the second connection surface form a common connection surface, wherein the folding region of the second wall is connected to the first wall and also to the second wall. In particular when a template is provided in the glue application apparatus for applying glue to the connection surface, it is sufficient to provide a single template, which reduces complexity and/or costs.

An advantageous embodiment of the invention provides that the bag is formed from a flat strip, wherein the edges of the flat strip are connected to each other along a connection seam extending in parallel to the longitudinal direction, wherein the connection seam is comprised by the second wall. The inventive method correspondingly provides that the connection seam is arranged on the second wall. This means that a flat strip is folded over along at least two lengthwise edges, wherein the edges of the strip overlap on the second wall and are connected to each other there. In an inventive system for producing a bag, a known tube forming device, in which the flat strip is folded upward (in relation to the conventional normal direction), can be provided for this purpose, which is followed by a flipping station. In such a system, the lengthwise seam can for example therefore firstly be mapped to the upper side of the tube, and after the bottom side is flipped over, which then represents the second wall on the separated tube pieces. The flat strip can alternatively also be flipped over toward the bottom.

Instead of providing a flipping station, the tube can also be formed by providing that the edges of the material strip are flipped toward the bottom such that said edges overlap underneath the first wall. This alternative is suited as the preferred solution, but if the invention is to be used for an already existing machine, it is expedient to provide a flipping station because the latter can be retrofitted.

The advantage of this aforementioned approach is that the connection seam is frequently pulled apart on the borders and edges by bonding to the template, in particular due to the effect of a template when applying glue to the first wall such that a bottom cannot always be properly formed. This circumstance is avoided by the aforementioned embodiment of the bag.

The bag can in this case principally be formed from a flat strip piece separated from a flat strip. It is also conceivable that the flat strip is in a first step processed into a tube from which the tube pieces are then separated.

A further advantageous embodiment of an inventive bag provides that a reinforcement element surrounding the handle opening is arranged between the second wall and the folding region. A handle element can in this manner be reinforced such that the bag can be safely used to carry even heavier loads and such that the risk of tearing the handle opening is reduced. This reinforcement element, which can for example be adapted as a sheet that in particular comprises paper, is positioned and connected onto the second wall and/or the folding region prior to sealing the bottom. This step is particularly preferably performed before forming a tube from a flat strip because the aforementioned regions are particularly readily accessible in this case. An applicator, which preferably uses a roller to apply the reinforcement elements onto the aforementioned regions at uniform distances, can be provided to perform this step. The applicator can in this case comprise an separation apparatus by which reinforcement elements can be separated from a further material strip.

The aforementioned task is further solved by a method for producing a bag, in particular a bag according to the above description, wherein tube pieces are provided or a tube is separated into tube pieces, wherein the tube pieces comprise a first wall and a second wall that are connected to each other by lateral edges such that a fill space is provided, wherein the tube piece is transported in a transportation direction, wherein the second wall projects above the first wall as seen in transportation direction, wherein a bottom is formed on the tube piece and wherein a folding region of the second wall is folded over at least parts of the first wall along a crease line.

The inventive method is characterized in that at least one handle opening is incorporated that reaches through the second wall outside of the folding region and through the folding region.

This method achieves the same advantages that have already been described above in connection with an inventive bag.

The aforementioned task is also solved by a system for producing a bag, in particular a bag and/or for executing the method according to the description above, having a device for providing tube pieces or having a device for individualizing a tube into tube pieces, wherein the tube pieces comprise a first wall and a second wall that are connected to each other by lateral edges such that a fill space is provided, having a transportation device for transporting the tube pieces in a transportation direction, wherein the second wall projects above the first wall as seen in transportation direction, having a bottom forming device to form a bottom onto the tube pieces, wherein a folding region can be folded over the second wall along a crease line onto at least parts of the first wall.

The inventive system is characterized by at least one device for incorporating at least one handle opening that reaches through the second wall outside of the folding region and through the handle opening.

This achieves the same advantages that have already been described above in connection with the inventive bag and/or the inventive method.

Further advantages, features, and details of the invention will be apparent from the following description, in which different exemplary embodiments are explained in detail with reference to the figures. The respective features mentioned in the claims and in the description can be essential to the invention individually or in any combination of mentioned features. Within the scope of the entire disclosure, features and details described in the context of the inventive bag naturally also apply respectively in the context of the inventive method and/or the inventive system, and respectively vice versa, such that cross reference is or can always be made with respect to the disclosure of the individual aspects of the invention. The individual figures show in:

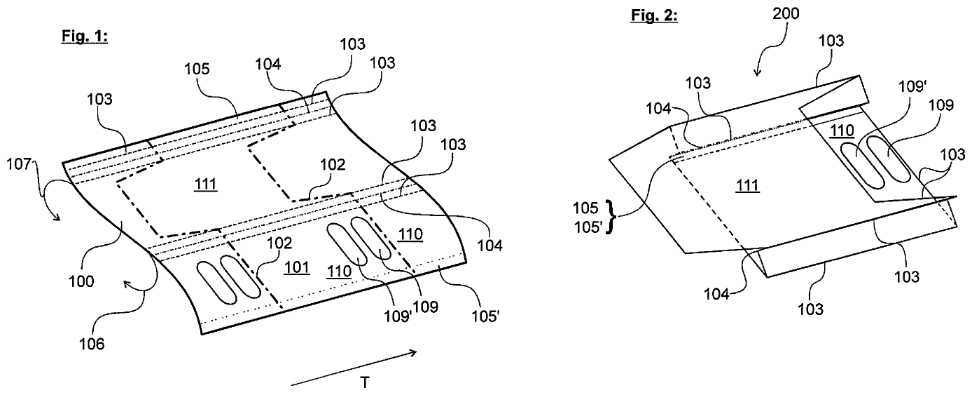

FIG. 1A material strip for producing inventive bags

FIG. 2A tube piece that was parted from the tube after the tube was formed

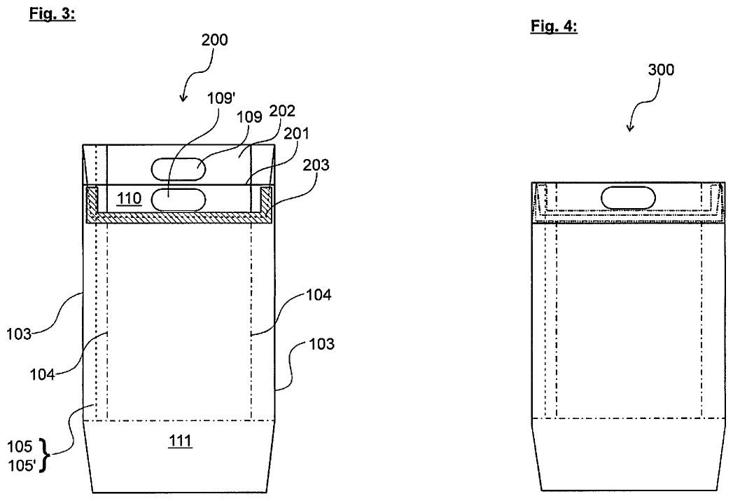

FIG. 3A top plan view onto the tube piece according to FIG. 2 after flat laying and applying an adhesive surface

FIG. 4A bag produced from the tube piece according to FIG. 3

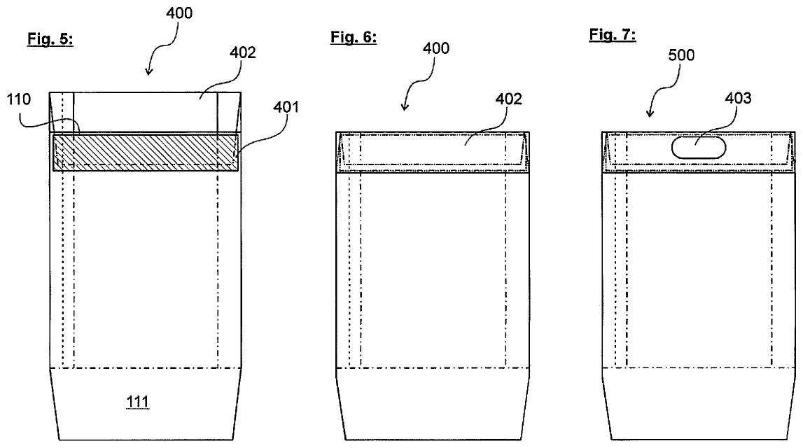

FIG. 5A top plan view onto the tube piece according to FIG. 2 after flat laying and applying an adhesive surface, but without incorporated handle openings

FIG. 6A bag produced from the tube piece according to FIG. 5, but without incorporated handle openings

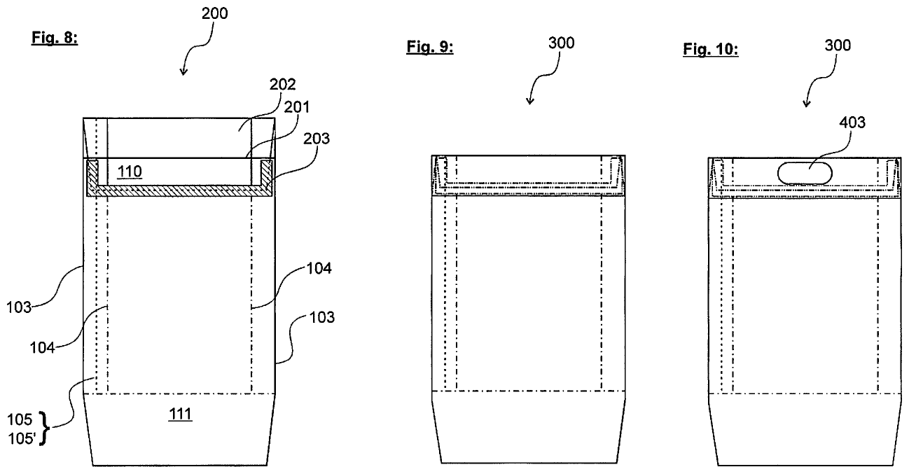

FIG. 7A produced bag according to FIG. 6 with additionally incorporated handle openings

FIG. 8A top plan view onto the tube piece according to FIG. 2 after flat laying and applying an adhesive surface, but without incorporated handle openings

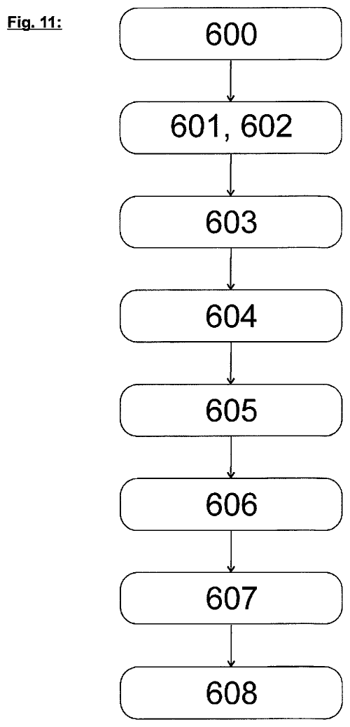

FIG. 9A bag produced from the tube piece according to FIG. 8, but without incorporated handle openings

FIG. 10A produced bag according to FIG. 9 with additionally incorporated handle openings

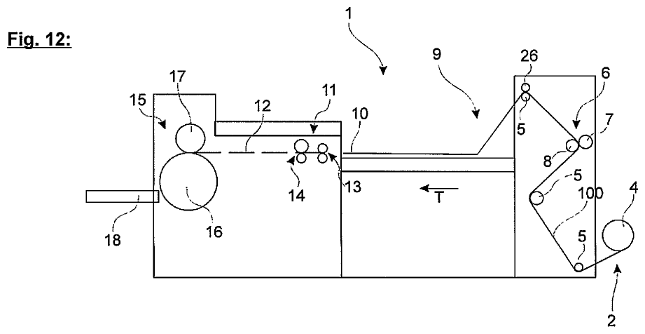

FIG. 11A flowchart of a method for producing the inventive bag

FIG. 12A device for producing the inventive bags

FIG. 1 shows a material strip 100, from which several inventive bags are or can be produced. The strip section 101, from which the tube section required to produce a bag is made, is indicated by bold dotted lines 102, that partially extend transverse to the transportation direction T of the flat strip 100. The lines 102 therefore represent dividing lines and can be formed by perforation. The lines 102 partially also have directional components in the direction of the transportation direction T, with the consequence that the two walls are arranged at an offset in relation to one another after individual tube pieces are subsequently torn off, which will be discussed in greater detail in the context of FIG. 2.

The flat strip is preferably shown as a view onto the exterior surfaces of the subsequent walls of the bag. The strip section 101 is divided into the surface region 110, which forms the predominant part of the subsequent second wall or completely forms the second wall, and the surface region 111, which forms the subsequent first wall. The surface regions 110 and 111 are bound by the next-closest dashed lines 103 or by the lines 104. Their significance is described below.

The dashed lines 103 and the dotted-dashed lines 104 indicate the optional side creases, wherein the lines 103 form the outer edges of a side crease, and the dotted-dashed lines 104 form the inner edge of a side crease. On bags without side creases, the lines 103 are omitted and the lines 104 form the outer lengthwise edges of the bag. The regions 105 and 105′ on the lengthwise edges of the flat strip 100 form the particular regions that overlap after tube forming and bond to each other, for example by gluing.

Handle openings—shown in FIG. 1, for example as handle holes—can already be incorporated into the material strip. For this purpose, two handle openings 109, 109′ are provided for each subsequent tube section such that these two handle openings 109, 109′ come to lie on top of each other after the step of folding over the bottom flap and together form a handle opening.

The curved arrows 106 and 107 now indicate that a tube will be formed from the material strip 100. Together with the tube forming, side creases can also be optionally incorporated since all creases that extend in transportation direction T are efficiently formed within a single station.

FIG. 2 now shows a tube piece 200, which is generated from the material strip shown in FIG. 1 by the tube forming and separation steps, which involve tearing off the respective front tube piece along the dividing line 102 by applying a force in direction T onto the respective front end of the tube and by holding the tube behind the respective first dividing line 102. The regions 105 and 105′ are arranged overlapping and are connected to each other by a connection, in particular by using adhesive. The lines 103 and 104 are likewise readily apparent. Concealed lines or line regions are shown by dashed or dotted-dashed lines.

It is evident that the region of the second wall 110, in which the handle openings 109, 109′ are arranged, is not covered by the first wall 111. But the first wall 111 extends on the rear end (as seen in transportation direction T) of the tube piece 200 beyond the second wall 110. The part of the first wall 111 extending beyond the second wall 110 is also frequently called a closure flap.

FIG. 3 now shows the tube section 200 in the top plan view. The individual features already described in the context of FIGS. 1 and 2 are also present. The subsequent crease line 201, about which the bottom flap 202 is folded over, is evident. An adhesive surface 203 was applied onto the tube piece in a further step, wherein said adhesive surface 203 is applied onto the first wall and also onto the second wall. The adhesive surface 203 has regions angled to the right and left and reaches closely to the crease edge 201. This achieves that the bottom flap 202 is connected to the exterior side of the first wall 111 and also to the interior side of the second wall 110. This also achieves that subsequently the region of the second wall in which the handle openings 109 and 109′ are arranged is sealed by the connection surface against the interior space of the subsequent bag, thus preventing access into the interior space through the handle openings.

FIG. 4 now shows the finished bag 300. In comparison to FIG. 3, only the bottom flap 202 needed to be folded over and pressed in about the crease line 201 onto the first wall 111. The merchandise to be filled can now be introduced into the interior space in the region of the closure flap. After sealing the bag, wherein the closure flap is folded over onto the second wall 110 and secured there, the bag can be carried by a user with the handle opening.

FIG. 5 now shows a variant of the tube section 400 for producing inventive bags. This tube section is adapted similarly to the tube section shown in FIG. 3. A description of a plurality of features is therefore omitted, and reference is made to FIG. 3 and the associated description. The differences are described below. It is firstly advantageous, but not mandatory, that handle openings are not incorporated into the material strip 100. Furthermore, the adhesive surface 401 differs from the adhesive surface 203 in that its shape differs therefrom, and is preferably adapted as a rectangle such that in particular the bottom flap 402, after folding over, is connected, in particular glued, over its entire surface to the interior side of the second wall and to the exterior side of the first wall.

After executing the step of folding over the bottom flap 402, the bag is sealed on one end, as shown in FIG. 6.

In order to obtain an inventive bag 500, a handle opening 403 is now incorporated into the bag bottom, wherein the handle opening is fully arranged in the region where the bottom flap 402 is directly connected to the interior side of the second wall 110. This circumstance is evident in FIG. 7.

The handle opening can also be incorporated prior to folding over the bottom flap 402. Likewise, it is possible to combine incorporating the handle opening after folding over the bottom flap with the embodiments according to FIGS. 1 to 4 and the associated description. Likewise, the adhesive surface in the embodiments described in the context of FIGS. 5 to 7 can be adapted analogously to the one shown in FIG. 3. The sequence for producing such a bag is evident in FIGS. 8, 9, and 10. The reference numbers in this case have the same meanings as described in the context of the preceding FIGS. 1 to 7.

FIG. 11 represents the sequence of a preferred method for producing an inventive bag. A material strip 100 is firstly provided in step 600. The handle openings 109, 109′ are incorporated into this material strip in step 601. During the optional step 602, which occurs shortly before, shortly after, or coterminously with step 601, the transverse perforations are incorporated into the material strip, which define the subsequent parting edges 102. In particular, the transverse perforation and incorporating the opening can be arranged in the same station in a device for producing inventive bags. It is then for example conceivable that a transverse perforation knife and punches for incorporating the openings are jointly arranged on a rotating element, for example a knife roller. Reinforcement sheets are applied during the optional step 603, for example by an application unit in the device. The tube is subsequently formed in step 604, in particular by coterminously folding in side creases. The tube is separated into tube sections in the subsequent step 605. This is followed in step 606 by applying an adhesive surface and in step 607 by folding over and attaching the bottom onto the first wall of the bag. The bag is then finished. When handle openings were not incorporated, said handle openings can be incorporated into the finished bottom in an optional step 608. Said step 608 can also occur between steps 605 and 606.

FIG. 12 shows a device 1 for producing bags. This figure shows a schematic representation of the principal elements of this device. The device 1 comprises an unrolling device 2 to which the material strip 100 is fed in the form of a winding 4. Originating from this winding 4, the material strip 100 is fed by guide rollers 5 to the transverse cutting station 6 or the perforating station 6, respectively. Said station 6 can comprise one or several transverse cutting or transverse perforating knives (not shown in detail), that revolve(s) on a roller 7. At the same time or in lieu thereof, punch elements can be arranged in this station and/or likewise revolve on the roller 7 to incorporate the handle openings 109, 109′. The material strip 100 advances in this station 6 over a counterpressure roller 8 that primarily has the purpose of providing the counterpressure required for the cutting or perforating operation. This cutting or perforating operation does not cut entirely through the strip, but the material strip 100 can instead be equipped with weakening cuts or perforations 102, along which the tube to be formed subsequently tears for separation into tube pieces.

The material strip 100 then advances through a roller gap of a roller formed by a further guide roller 5 and by a roller adapted as a lengthwise glue applicator 26. The latter applies glue onto a side region of the material strip 3 such that both side regions are permanently connected to each other after tube forming, as described below.

The then following tube forming station 9 forms a tube 10 from the material strip 100 by laterally folding in the material strip 100 using guide elements, for example sheet-metal guides, such that the edges of the material strip subsequently overlap. The subsequently overlapping regions have already had suitable adhesive applied by the lengthwise glue applicator 26. Lateral creases can also be incorporated while folding in the paper strip. But the side creases can also be incorporated after tube forming. The tube 10 is now usually conveyed further in transport direction T.

After the tube 10 was generated, the latter is separated into tube pieces 12 in the tear-off station 11. The tube 10 is for this purpose guided through the roller gap of a first roller pair 13. As the tube advances further, the latter enters the roller gap of a second roller pair 14. The rollers of the second roller pair constantly or at least temporarily have a greater circumferential speed than the rollers of the first roller pair 13, whose circumferential speed advantageously matches the transportation speed of the tube 10. When the next perforation as seen from the advancing end of the tube has passed the roller gap of the first roller pair 13, the second roller pair 14 grabs onto the tube 10. This can occur when the advancing end of the tube advances into the roller gap of the second roller pair. But the rollers of the second roller gap 14 can also be moved relative, for example vertically, in relation to the tube 10 to be placed into contact with the tube. When the rollers of the second roller gap 14 make contact with the tube, the tube tears along the cut or the perforation, respectively, that was incorporated into the strip in station 6.

One of the rollers of the first roller pair 13 can also carry a cutting knife by which the tube can be separated into individual tube pieces 101 using so-called blanking cuts. In this case, the perforation of the flat strip within station 6 can be omitted. It is advantageous in this case that the upper edge of the bag has a substantial border that does not exhibit exposed fibers or fraying, as is the case when tube pieces are torn off.

After the tube piece 200 is torn off the tube, the former now enters the bottom glue application and bottom folding-over station 15. For this purpose, the tube piece 200 is held in place on the bottom maker cylinder 16. The advancing end of the tube piece is folded over by a suitable element, for example a rod, such that parts of the bottom (second) wall are folded back together with parts of the upper (first) wall such that parts of the upper wall come to lie on the upper layer, and also parts of the lower wall come to lie on the upper layer through the openings. Prior thereto, an adhesive, for example glue, is applied to the tab and/or the region of the exterior side of the upper wall on which the tab comes to lie after folding over. This is accomplished by the glue application device, which is symbolized in FIG. 12 by the glue cylinder 17.

After the bag is finished, the latter is placed on a table 18 by the bottom maker cylinder 16. The bags are in this case generally arranged standing upright. The bags can then be suitably picked from this table 18 in stacks.

List of Reference Numbers

| | |
|---|---|
| 1 | Device for producing bags |
| 2 | Unrolling device |
| 3 | Material strip |
| 4 | Winding |
| 5 | Guide roller |
| 6 | Transverse cutting station/perforation station |
| 7 | Roller |
| 8 | Counterpressure roller |
| 9 | Tube forming station |
| 10 | Tube |
| 11 | Tear-off station |
| 12 | Tube piece |
| 13 | Roller pair |
| 14 | Second roller pair |
| 15 | Bottom glue application and bottom folding-over station |
| 16 | Bottom maker cylinder |
| 17 | Glue cylinder |
| 18 | Table |
| 100 | Material strip |
| 101 | Strip section |
| 102 | Parting line |
| 103 | Lines |
| 104 | Lines |
| 105, 105′ | Region |
| 106 | Arrow |
| 107 | Arrow |
| 109, 109′ | Handle opening |
| 110 | Surface region |
| 111 | Surface region |
| 200 | Tube piece |
| 201 | Crease line |
| 202 | Bottom flap |
| 203 | Adhesive surface |
| 300 | Finished bag |
| 400 | Tube section |
| 401 | Adhesive surface |
| 402 | Bottom flap |
| 403 | Handle opening |
| 500 | Inventive bag |
| 600 | Step for providing a material strip 100 |
| 601 | Step for incorporating the handle openings 109, 109′ |
| 602 | Optional step for incorporating transverse perforations |
| 603 | Optional step for applying reinforcement sheets |
| 604 | Step for tube forming |
| 605 | Step for individualizing the tube into tube pieces |
| 606 | Step for applying an adhesive surface |
| 607 | Step for folding over and attaching the bottom |
| 608 | Optional step for incorporating handle openings into the |
| | finished bottom |
| T | Transportation direction |

1. A bag (300),
having a first wall and a second wall that comprise paper and that are connected to one another by lateral edges such that a fill space is provided, wherein the second wall projects above the first wall as seen in the longitudinal direction of the bag,
having two ends, wherein a bottom is arranged on one end and an opening is provided on the other end, through which the fill space is accessible, wherein the bottom comprises at least one folding region of the second wall, wherein the folding region is folded over at least parts of the first wall about a crease line, and
having at least one handle opening (109, 109′),
characterized in that
the handle opening (109, 109′) reaches through the second wall outside of the folding region and through the folding region.

2. The bag (300) according to claim 1,
characterized in that
the folding region is connected to the first wall by a first connection surface, wherein the folding region is connected to a second connection surface with a side of the second wall facing the fill space.

3. The bag (300) according to claim 1,
characterized in that
the second connection surface fully envelops the handle opening (109, 109′).

4. The bag (300) according to claim 1,
characterized in that
the first and the second connection surface form a common connection surface, wherein the folding region of the second wall is connected to the first wall and also to the second wall.

5. The bag (300) according to claim 1,
characterized in that
the bag is formed from a flat strip (100), wherein the edges of the flat strip (100) are connected to each other along a connection seam extending in parallel to the longitudinal direction, wherein the connection seam is comprised by the second wall.

6. The bag (300) according to claim 1,
characterized in that
the handle opening (109, 109′) is formed by at least one punch-out.

7. The bag (300) according to claim 1,
characterized in that
the handle opening (109, 109′) is formed by at least one perforation, wherein the handle opening (109, 109′) is formed further by grabbing through.

8. The bag (300) according to claim 1,
characterized in that
a reinforcement element is circumferentially arranged about the handle opening (109, 109′) between the second wall and the folding region.

9. A method for producing a bag (300), in particular a bag (300) according to claim 1, wherein tube pieces (200) are provided or a tube is separated into tube pieces (200), wherein the tube pieces (200) comprise a first wall and a second wall that are connected to each other by lateral edges such that a fill space is provided, wherein the tube piece (200) is transported in a transportation direction (T), wherein the second wall projects above the first wall as regarded in transportation direction (T), wherein a bottom is formed on the tube piece (200) and wherein a folding region of the second wall is folded over at least parts of the first wall along a crease line,
characterized in that
at least one handle opening (109, 109′) is incorporated that reaches through the second wall outside of the folding region and through the folding region.

10. The method according to claim 9,
characterized in that
the handle opening (109, 109′) is incorporated after forming the bottom.

11. The method according to claim 9,
characterized in that
the handle opening (109, 109′) is incorporated prior to forming the bottom, wherein a first opening is incorporated into the folding region and a second opening is incorporated into the second wall outside of the folding region, wherein both openings come to lie on top of one another after the bottom is formed.

12. A system for producing a bag (300), in particular a bag (300) according to claim 1, having a device for providing tube pieces (200) or having a device for separating a tube into tube pieces (200), wherein the tube pieces (200) comprise a first wall and a second wall that are connected to each other by lateral edges such that a fill space is provided,
having a transportation device for transporting the tube pieces (200) in a transportation direction, wherein the second wall projects above the first wall as seen in transportation direction, having a bottom forming device to form a bottom onto the tube piece (200), wherein a folding region can be folded over the second wall along a crease line (201) onto at least parts of the first wall,
characterized by
at least one device (601) for incorporating at least one handle opening (109, 109′) that reaches through the second wall outside of the folding region and through the folding region.

13. A system for producing a bag (300) in particular a bag (300) for executing the method according to claim 9, having a device for providing tube pieces (200) or having a device for separating a tube into tube pieces (200), wherein the tube pieces (200) comprise a first wall and a second wall that are connected to each other by lateral edges such that a fill space is provided, having a transportation device for transporting the tube pieces (200) in a transportation direction, wherein the second wall projects above the first wall as seen in transportation direction, having a bottom forming device to form a bottom onto the tube piece (200), wherein a folding region can be folded over the second wall along a crease line (201) onto at least parts of the first wall,
characterized by
at least one device (601) for incorporating at least one handle opening (109, 109′) that reaches through the second wall outside of the folding region and through the folding region.
